(19) United States
(12) Patent Application Publication
(10) Pub. No.: US 2007/0187910 A1
(43) Pub. Date: Aug. 16, 2007

(54) Pusher for stroller

(76) Inventor: Jacqueline Adams, Beaufort, SC (US)

Correspondence Address: B. Craig Killough;Barnwell Whaley Patterson & Helms, LLC, P.O. Drawer H, Charleston, SC, 29402-0197, US

(21) Appl. No.: 11/354,538

(22) Filed: Feb. 15, 2006

(51) Int. Cl. B62D 51/04

(52) U.S. Cl. 280/1.5

(57) ABSTRACT

A belt or similar wearable device that is worn about the midsection or waist of the user. A rod is connected to a wheeled vehicle. The rod is mounted to the belt by mounting that permits the rod to pivot both horizontally and vertically, and otherwise, relative to the belt.

### FIELD OF THE INVENTION

This invention relates to a device that assists in propelling a non-motorized wheeled vehicle, such as a stroller for a child.

### BACKGROUND OF THE INVENTION

Running, jogging and walking are popular forms of exercise. People run, walk and jog on sidewalks or paths that are created for this purpose. When running, jogging or walking, it is preferred to have the hands and arms free, since movement of the arms facilitates running, jogging, and walking, and enhances the benefit of the exercise.

In some cases it is desirable to push a wheeled vehicle while running, jogging or walking. The most common example is a wheeled vehicle into which a baby or small child may be placed. Strollers are available with relatively large wheels that have little rolling resistance, and are specifically made for transporting a child while a parent or other caretaker runs, jogs or walks behind the stroller. However, other forms of wheeled vehicles, such as carts for carrying groceries, beach items, or picnic supplies, may be pushed while running, walking or jogging. Similarly, in these cases, it is desirable to have the hands and arms free.

### SUMMARY OF THE PRESENT INVENTION

The present invention comprises a belt or similar wearable device that is worn about the midsection or waist of the user. A rod is connected to a wheeled vehicle. The rod is mounted to the belt by mounting that permits the rod to pivot both horizontally and vertically, and otherwise, relative to the belt.

### DESCRIPTION OF THE DRAWINGS

FIG. 1 demonstrates the invention as worn by a user and as connected to a stroller.

FIG. 2 shows the invention in isolation with the rod removed from the belt.

FIG. 3 shows the invention in isolation, demonstrating that the length of the rod may be varied, and that the handle mounting of the device may be varied.

FIG. 4 is an isolation of the invention demonstrating that the rod pivots relative to the belt.

### DETAILED DESCRIPTION OF THE PREFERRED EMBODIMENT

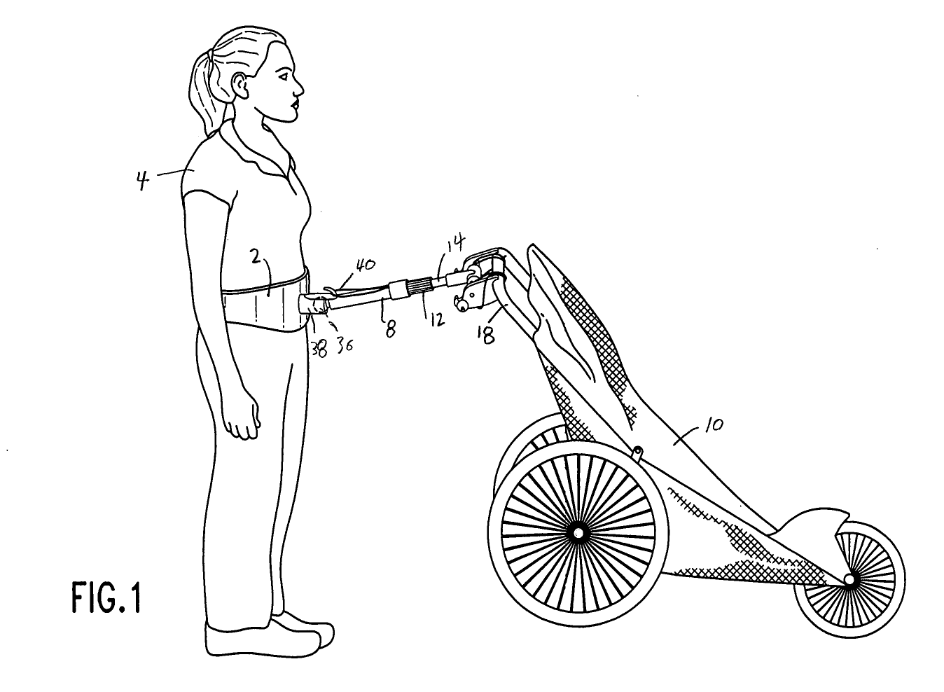

Referring now to the drawing figures, the device comprises a belt 2 that is worn by a user 4. Typically, the belt is worn about a mid-section, such as a waist, of the user. The term “belt” is used to mean a device that can be worn by a user, and typically but not inherently, the belt is wrapped completely around the user as shown in FIG. 1. The belt may be held in place by hook and loop material 6 or other means for connecting belts. Alternatively, the belt is not annular, but for example, may be fixed to hook and loop material that is otherwise worn by the user.

A rod 8 is mounted to the wheeled vehicle 10. The wheeled vehicle is not motorized while being pushed by the device of the present invention. The wheeled vehicle could be motorized, but the motor should not be engaged while the present invention is used, and accordingly, the vehicle is described as being non-motorized. The vehicle may be a stroller for transporting children, but may be another form of wheeled vehicle device, such as a cart for transporting articles.

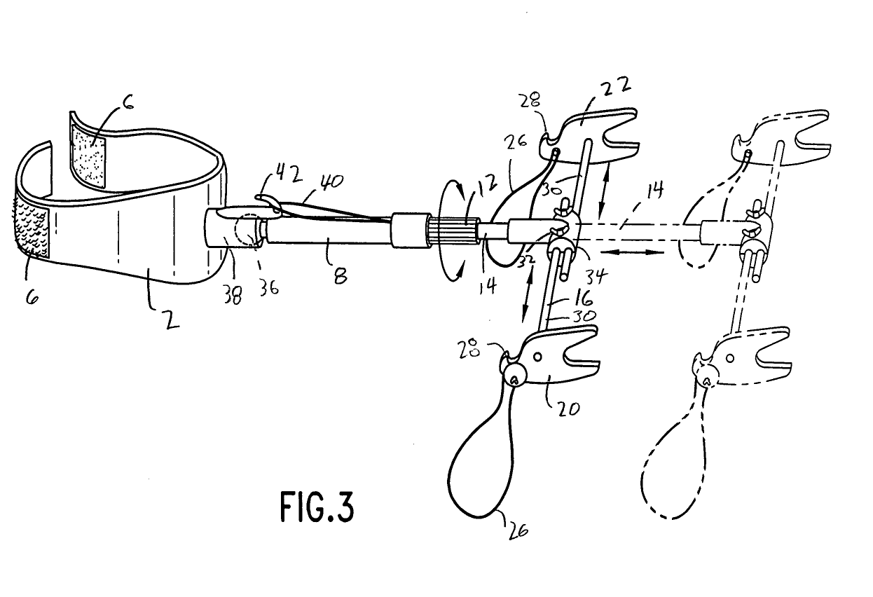

In a preferred embodiment, the rod is rigid, and when in use, the rod does not pivot or move relative to the wheeled vehicle. However, the rod may be provided with various adjustments. As demonstrated in FIG. 3, the length of the rod is variable, such as by providing a telescoping mechanism. For example, a collar 12 may be rotated that allows a first portion 14 of the rod to be withdrawn from, or retracted into, another portion of the rod, so as to lengthen or shorten the rod as desired. The collar may then be rotated to secure the telescoping portions of the rod in place once the proper length is achieved. Other known telescoping devices may be employed. The length of the rod may be adjusted according to the height of the user, the nature of the wheeled vehicle, the height of the mounting point of the rod on the wheeled vehicle, and otherwise, as preferred by the user, for the user's safety and comfort, and for the safety and comfort of a child being pushed in the stroller.

The rod need not be solid, and in fact, may be one or more tubes that are slideable within each other to vary the overall length of the rod. However, the rod, or the assembly forming the rod, is relatively static and relatively rigid when positioned for use.

In a preferred embodiment as shown, a handle mounting 16 for the device is provided. The device may be mounted on the wheeled vehicle at points other than the handle 18 of the wheeled vehicle, but most commonly, as with strollers and carts, a generally horizontal handle is provided for manually pushing the wheeled vehicle. The handle is usually the most convenient and effective mounting point for the device.

In the embodiment shown in the drawing figures, the handle mounting has opposite ends 20, 22. Each opposite end has a generally V-shaped opening 24 which accommodates handles of various sizes. A retaining strap 26 is looped around the handle to secure each end of the handle mounting to the handle of the wheeled vehicle as shown in FIG. 1. The retaining strap may be looped around the handle and secured at the hook 28 that is provided on an end of each of the handle mountings.

Also as shown in a preferred embodiment, and as demonstrated in FIG. 3, each end of the handle mounting is mounted to a slideable rod 30. Thumb screws 32 or similar devices may be used to loosen pressure on the housing 34 in which the rods are retained.

The rods and the ends may be adjusted horizontally, and when the proper position of the ends relative to the handles is achieved, thumb screws are tightened to secure the ends in place.

An end 36 of the rod that is opposite the wheeled vehicle is secured in a mounting 38. The mounting is preferred to be held by or mounted to the belt 2. The end of the rod is preferred to have an arcuate shape, so that a bearing surface is provided relative to the mounting, since the mounting allows the rod to pivot relative to the mounting. In a preferred embodiment, the end of the rod has a ball shape, so that the mounting and the end of the rod form a ball and socket.

In a preferred embodiment, the ball is easily removable from the mounting. The ball and socket are not joined by a press fit or other frictional engagement that inhibits the end of the rod from being removed from the mounting, but rather, the ball fits relatively loosely within the socket. When the device is in use, if the user needs to attend to the needs of a child that is in the stroller, it is a very simple matter to disengage the rod from the mounting, so that the user is not connected to the rod, and the stroller, and the user can easily and quickly attend to the needs of the child.

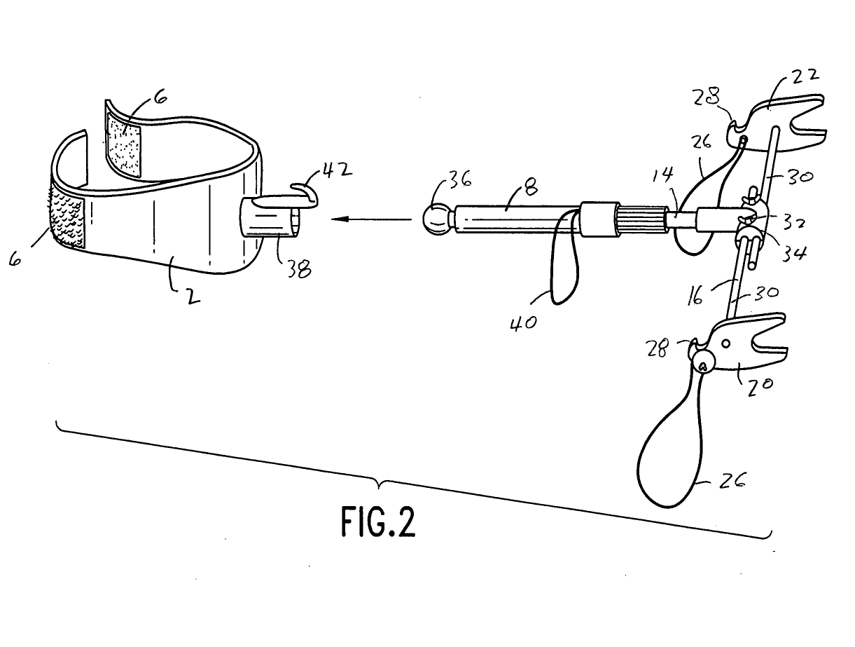

The end 36 of the rod is retained in the mounting 38 by spring biasing, rather than by retaining the rod to the mounting or to the belt by use of a screw or similar fastener, or by a frictional fit between the ball and socket. “Spring biasing” refers to a spring, or to an elastic property that will tend to urge the mounting toward the rod, and the rod toward the mounting, when the spring biasing device is connected. In a preferred embodiment, spring biasing is provided by a band or loop having elastic properties, such as an elastic or rubber band, or a shock cord. As shown in FIG. 2, the ball on the end of the rod is inserted into the socket of the mounting. The elastic band 40 is then looped over a hook 42 that is provided, and may be positioned on the mounting. The elastic band urges the mounting toward the rod, and holds the mounting in place. If the user needs to disconnect to attend to the child that is in the stroller, or should otherwise desire to disengage from the stroller, it is a simple matter to remove the end of the elastic band from the hook and to remove the ball and rod from the mounting and the belt. Accordingly, disengagement, or engagement, can be accomplished in a matter of seconds. The relatively large orifice in the mounting and the relatively large ball make insertion of the ball into the socket easy, with minimal manual dexterity required, and the elastic band is readily and easily placed over the hook to urge the ball and socket toward each other. When the elastic band becomes worn or tired, and no longer has efficient spring biasing property, it is a simple matter to replace the elastic band.

The use of the ball and socket of the preferred embodiment, or other rod having an arcuate end, creates a bearing surface, and allows the rod to pivot relative to the belt. All points of the rod relative to the handle mounting and the wheeled vehicle are fixed in place once the device is in use, although as noted, the length of the rod, and the handle mounting, are adjustable to allow the device to be used with many available wheeled vehicles that may be manually pushed.

The device as used is shown in FIG. 1. The user places a belt around his or her mid-section, such as about his or her waist. The handle mounting is adjusted horizontally, as required to mount the device to the handle of the wheeled vehicle, such as the stroller. Retaining straps are looped around the handle, and retained in the hooks provided on the ends of the handle mounting, or by otherwise securing the retaining straps to the ends of the handle mounting. The length of the rod is adjusted according to the height of the handle of the wheeled vehicle, the height of the user, and otherwise, for comfort and safety while using the device. The end of the rod is inserted into the mounting, such as by inserting the ball into the socket of the mounting. The elastic loop is then positioned so that the end of the elastic loop that is closest to the user is retained in place by the hook. The elastic loop is under some amount of tension so that the ball is held in place in the socket by the urging of the tension on the elastic loop. The device is ready for use.

In use, the user can push the stroller while running, jogging or walking without having to use his or her hands. The forward motion of the user while running, jogging or walking, transmits a force from the belt, mounting, rod and handle mounting to the wheeled vehicle, and causes forward motion of the wheeled vehicle. Similarly, the user may carefully back the wheeled vehicle by walking backwards, being careful not to disengage the rod from the mounting, or by hold the rod with a hand.

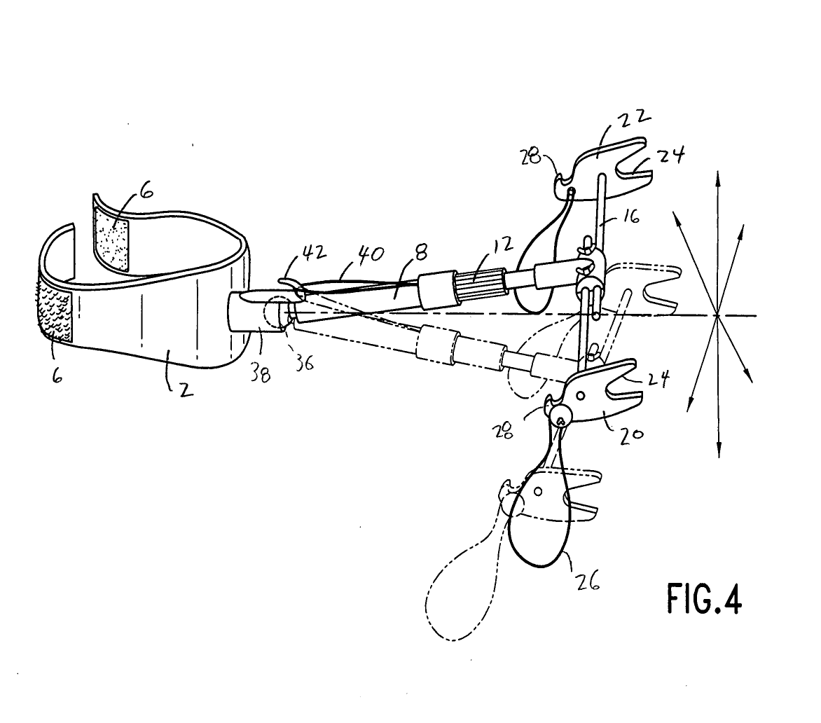

Positioning the end of the rod, such as a ball, into the mounting, such as a socket, allows the rod to pivot horizontally and vertically in use, and to pivot in the x and y axes, as demonstrated by the arrows shown in FIG. 4. The pivotal mounting allows the device to be steered by the user by varying the direction of travel of the user. If the user wishes to steer the device to the left, the user veers slightly to the right, and if the user wishes to steer to the right, the user veers slightly to the left, which is similar to backing a trailer that is pushed by a car or a truck. With practice, the user can become adept at steering the device without the use of hands, although the user may wish to keep the handle of the wheeled vehicle within his or her reach.

While the pivotal mounting of the rod relative to the belt allows pivoting through a relatively wide range of angles, the rod is rigidly mounted to the wheeled vehicle, and the user is able to control the wheeled vehicle with success, since the angle of the mounting relative to the belt is controlled completely by the user's positioning of the belt relative to the rod. Further, while a wide range of angles is available from the pivot point, the travel of the rod in the mounting is not infinite, due to the height of the user, which limits travel in the y axis, and the inherent nature of the mounting, with regard to the x axis. Pivoting in the y axis permits the user to bounce up and down while running, jogging or walking, as a normal consequence of running, jogging or walking. A larger travel of the rod is typically available in the x axis, which is useful in steering the device. The user will learn to control the travel in the x axis for steering the wheeled vehicle.

What is claimed is:

1. A pushing device for a wheeled vehicle, comprising:
a) a belt that is worn about the midsection of a user;
b) a rod that is connected to a wheeled vehicle; and
c) a mounting that connects said rod to said belt, wherein said mounting permits said rod to pivot horizontally and vertically relative to said mounting when said wheeled vehicle is pushed by a force applied to said rod through said belt.

2. A pushing device for a wheeled vehicle as described in claim 1, wherein said mounting is a ball and socket.

3. A pushing device for a wheeled vehicle as described in claim 1, further comprising a spring biased retainer that connects said belt to said rod.

4. A pushing device for a wheeled vehicle as described in claim 2, further comprising a spring biased retainer that connects said belt to said rod, wherein
said spring biased retainer holds said ball in said socket.

5. A pushing device for a wheeled vehicle as described in claim 3, wherein said spring biased retainer is an elastic band that is attached to said belt and to said rod.

6. A pushing device for a wheeled vehicle as described in claim 3, wherein one end of said spring biased retainer is positioned about a hook.

7. A pushing device for a wheeled vehicle as described in claim 1, wherein a length of said rod is varied by sliding a first portion of said rod relative to a second portion of said rod.

8. A pushing device for a wheeled vehicle as described in claim 1, wherein said rod is mounted to said wheeled vehicle by a handle mounting that mounts to a handle of said wheeled vehicle, wherein a position of said handle mounting is horizontally adjustable relative to said rod.

9. A pushing device for a wheeled vehicle as described in claim 1, wherein said rod is mounted to said wheeled vehicle by a handle mounting that mounts to a handle of said wheeled vehicle, wherein said handle mounting is horizontally slideable relative to said rod, and wherein a position of said handle mounting is horizontally adjustable relative to said rod.

10. A pushing device for a wheeled vehicle as described in claim 1, wherein said rod is mounted to said wheeled vehicle by a handle mounting that mounts to a handle of said wheeled vehicle, wherein said handle mounting has a first end that is one side of said rod and a second end that is on an opposite side of said rod, wherein a distance between said first end and said second end is horizontally variable.
